(19) United States
(12) Patent Application Publication
(10) Pub. No.: US 2019/0368712 A1
(43) Pub. Date: Dec. 5, 2019

(54) LIGHT SOURCE DEVICE FOR ILLUMINATION APPARATUS

(71) Applicant: PANASONIC INTELLECTUAL PROPERTY MANAGEMENT CO., LTD., Osaka (JP)

(72) Inventor: Hiroshi KITANO, Osaka (JP)

(73) Assignee: PANASONIC INTELLECTUAL PROPERTY MANAGEMENT CO., LTD., Osaka, JAPAN

(21) Appl. No.: 16/425,466

(22) Filed: May 29, 2019

(30) Foreign Application Priority Data
May 31, 2018 (JP) 2018-105336

(51) Int. Cl. F21V 29/10; F21V 8/00; G02B 27/28; F21V 9/14

(52) U.S. Cl. CPC F21V 29/10; G02B 6/0006; F21Y 2115/30; F21V 9/14; G02B 27/285

(57) ABSTRACT

A light source device is provided with: a first laser device that emits a first laser light; a second laser device that emits a second laser light, with the second laser light having an optical axis extending substantially parallel to an optical axis of the first laser light; a first optical axis translator that translates the optical axis of the first laser light; and a second optical axis translator that translates the optical axis of the second laser light A distance between the optical axis of the first laser light before translation and the optical axis of the second laser light before translation is greater than a distance between the optical axis of the first laser light after translation and the optical axis of the second laser light after translation.

### CROSS REFERENCE TO RELATED APPLICATION

The entire disclosure of Japanese Patent Application No. 2018-105336 filed on May 31, 2018 including the specification, claims, drawings, and abstract is incorporated herein by reference in its entirety.

### TECHNICAL FIELD

The present disclosure relates to a light source device used for an illumination apparatus.

### BACKGROUND

As a light source device for an illumination apparatus, a light source device that is provided with a substrate and a plurality of LEDs (light emitting diodes) implemented on the substrate is known, as described in Japanese unexamined Patent Application Publication No. 2017-174742 A.

### SUMMARY

### Technical Problem

When laser devices are used instead of LEDs as light emitting devices, it is possible to realize an excellent illumination apparatus with a high brightness, in the case of mounting laser devices on an illumination apparatus, however, a problem having the following tradeoff relationship exists. Specifically, laser devices generate a large amount of heat. Therefore, in the case of implementing a plurality of laser devices on a substrate, it is necessary to efficiently dissipate heat generated by each laser device so that thermal damage is not caused on the laser device, and a larger distance (pitch) between adjoining laser devices is better.

In the case of using laser devices as an illumination apparatus, a configuration is conceivable in Which laser lights from the plurality of laser devices are bundled, caused to enter the same optical fiber, and caused to move to an appropriate position. However, an optical fiber with a large diameter is very expensive. Therefore, if the distance between adjoining laser devices is increased to suppress thermal damage of the laser devices, and a laser light from each laser device is caused to travel straight and enter an optical fiber, the optical fiber is an expensive optical fiber with a large diameter, and manufacturing cost is increased.

Therefore, an advantage of the present disclosure is to provide a light source device for an illumination apparatus which may sufficiently perform heat dissipation of laser devices and, moreover, for which an optical fiber with a small diameter may be used.

### Solution to Problem

In order to solve the above problem, a light source device for an illumination apparatus of the present disclosure comprises a first laser device that emits a first laser light; a second laser device that emits a second laser light, the second laser light having an optical axis extending substantially parallel to an optical axis of the first laser light; a first optical axis translator that translates the optical axis of the first laser light emitted from the first laser device; and a second optical axis translator that translates the optical axis of the second laser light emitted from the second laser device; wherein a distance between the optical axis of the first laser light before translation by the first optical axis translator and the optical axis of the second laser light before translation by the second optical axis translator is greater than a distance between the optical axis of the first laser light after translation by the first optical axis translator and the optical axis of the second laser light after translation by the second optical axis translator.

### Advantageous Effect of Invention

According to a light source device for an illumination apparatus according to the present disclosure, heat dissipation of laser devices may be sufficiently performed, and, moreover, an optical fiber with a small diameter may be used.

### BRIEF DESCRIPTION OF DRAWINGS

The figures depict one or more implementations in accordance with the present teaching, by way of example only, not by way of limitations. In the figures, like reference numerals refer to the same or similar elements.

An embodiment of the present disclosure will be described based on the following figures, wherein:

FIG. 1 is a schematic configuration diagram of a light source device for an illumination apparatus according to an embodiment and is a plan view when the light source device is seen from above;

FIG. 2 is a plan view of a light source device for an illumination apparatus of a modification corresponding to FIG. 1;

FIG. 3 is a plan view of a light source device for an illumination apparatus of a further modification corresponding to FIG. 1;

FIG. 4 is a plan view of a light source device for an illumination apparatus of another modification corresponding to FIG. 1;

FIG. 5 is a schematic diagram illustrating a structure of a second mirror used in the modification shown in FIG. 4; and

FIG. 6 is a plan view of a light source device for an illumination apparatus of a different modification corresponding to FIG. 1.

### DESCRIPTION OF EMBODIMENT

An embodiment according to the present disclosure will be described below in detail with reference to accompanying drawings. It is originally assumed that, when a plurality of modifications and the like are included below, their characteristics parts are appropriately combined to construct a new embodiment. In the example below, the same reference numeral will be given to the same components in the drawings, and duplicated description will be omitted. The plurality of drawings include schematic diagrams, and dimensional ratios among length, width and height of each member are not necessarily the same among different diagrams, in the present specification, the word “substantially” is used with the same meaning as the phrase “roughly speaking”, and requirements for “substantially” are satisfied if what is expressed, being accompanied by the word, is generally recognized by a person as expressed.

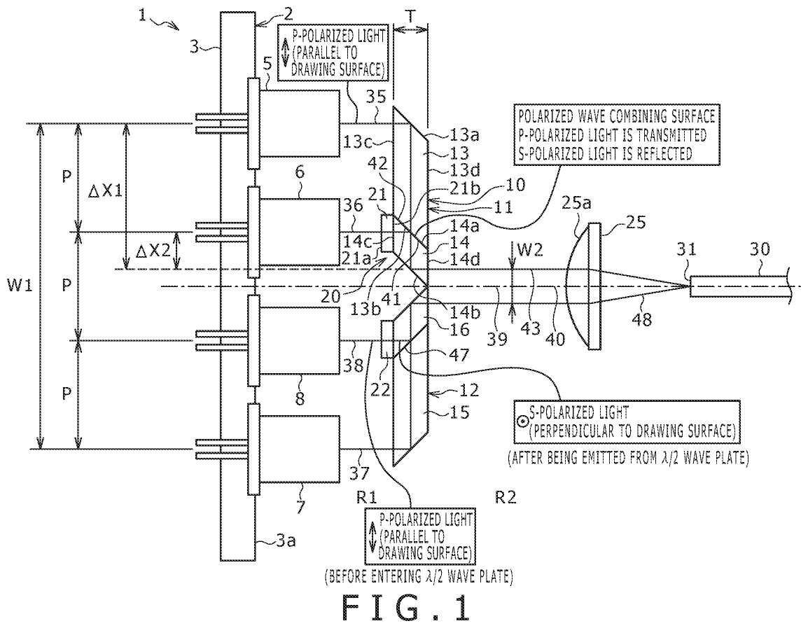

FIG. 1 is a schematic configuration diagram of a light source device 1 for an illumination apparatus according to an embodiment and is a plan view when the light source device is seen from above. As shown in FIG. 1, the light source device 1 is provided with a light source substrate 2, an optical axis translating portion 10, a polarization state changing portion 20, a condensing lens 25 and an optical fiber 30. The light source substrate 2, the optical axis translating portion 10, the condensing lens 25 and the optical fiber 30 are fixed to a case (not shown) via holders (not shown). The polarization state changing portion 20 is configured integrally with the optical axis translating portion 10, which will be described in detail later.

The light source substrate 2 includes a substrate 3 and first to fourth semiconductor laser devices (hereinafter merely referred to as laser devices) 5 to 8 implemented on the substrate 3. The substrate 3 is configured with a substrate of metal material such as aluminum or copper, and configured so that heat generated by the laser devices 5 to 8 is efficiently dissipated to the outside air via the substrate 3. If a heat dissipation module such as a heat sink is attached to the back of the substrate 3, dissipation of the heat generated by the laser devices 5 to 8 can be preferably improved.

The first to fourth laser devices 5 to 8 are implemented on the same line on an implementation surface 3a of the substrate 3 at intervals. The laser devices 5 to 8 are configured with the same laser devices that emit, for example, blue laser light. Each of the laser devices 5 to 8 is configured, for example, with a laser device of TO-can package type but may be configured with any type of laser device.

The optical axis translating portion 10 is provided with one first polarized wave combining prism 11 as an example of a first optical axis translator and one second polarized wave combining prism 12 as an example of a third optical axis translator. The polarization state changing portion 20 is provided with a first wave plate 21 and a second wave plate 22. Each of the wave plates 21 and 22 includes birefringent material and the like and gives a phase difference (an optical path difference) to two polarized components orthogonal to each other to change a state of incident polarization. Each of the wave plates 21 and 22 is configured, for example, with a λ/2 wave plate. In this case, each of the wave plates 21 and 22 gives a phase difference of π (=λ/2) in an electric field oscillation direction (to a polarization plane) of incident light.

The first laser device 5 emits first laser light 35, and the second laser device 6 emits second laser light 36. The third laser device 7 emits third laser light 37, and the fourth laser device 8 emits fourth laser light 38. On a sectional view of a section including an optical axis of the first laser light 35 before entering the first polarized wave combining prism 11 and an optical axis of the second laser light 36 before entering the first polarized wave combining prism 11, a reference axis 39 exists, relative to which the first laser device 5 and the third laser device 7 are substantially line-symmetric. On the sectional view, the second laser device 6 and the fourth laser device 8, the first polarized wave combining prism 11 and the second polarized wave combining prism 12, and the first wave plate 21 and the second wave plate 22, are substantially line: symmetric relative to the reference axis 39.

More specifically, the light source substrate 2 is arranged substantially plane-symmetrically relative to a plane (hereinafter referred to as a symmetry plane) 40 that includes the reference axis 39 and a line perpendicular to the surface of FIG. 1. The first laser device 5 and the third laser device 7, and the second laser device 6 and the fourth laser device 8, are also arranged substantially plane-symmetrically relative to the symmetry plane 40. Further, the first polarized wave combining prism 11 and the second polarized wave combining prism 12, and the first wave plate 21 and the second wave plate 22, are also arranged substantially plane-symmetrically relative to the symmetry plane 40. An arrangement structure and the like will be described below for components arranged on an area on one side of the light source substrate 2, the optical axis translating portion 10, and the polarization state changing portion 20, with the symmetry plane 40 as a border, that is, the first laser device 5, the second laser device 6, the first polarized wave combining prism 11, and the first wave plate 21, Description of an arrangement structure and the like which is the same arrangement structure for components arranged on an area on the other side with the symmetry plane 40 as the border, that is, the third laser device 7, the fourth laser device 8, the first polarized wave combining prism 11, and the second wave plate 22, will be omitted.

The first polarized wave combining prism 11 includes a first prism 13, a second prism 14 and a dielectric multilayer film 42 including a polarized wave combining surface 41. The first prism 13 includes a slope 13a that causes the first laser light 35 emitted from the first laser device 5 to be totally reflected to the second polarized wave combining prism 12 side in such a manner that it is substantially orthogonal to a thickness direction of the first prism 13, and a slope 13b extending substantially in parallel to the slope 13a and facing the slope 13a. Further, the first prism 13 includes a pair of side faces 13c and 13d extending substantially parallel to a travel direction of the first laser light 35 that has been totally reflected, on the plan view shown in FIG. 1. On the sectional view of the section including the optical axis of the first laser light 35 and the optical axis of the second laser light 36, the first prism 13 has a substantially parallelogram sectional shape. A thickness direction of the first prism 13 substantially corresponds to an extension direction of the optical axis of the first laser light 35 before entering the first polarized wave combining prism 11. A thickness of the first prism 13 may be any thickness, but is preferably ⅓ of a distance P between optical axes of the first laser device 5 and the second laser device 6 (a pitch between the first laser device 5 and the second laser device 6), or less.

The second prism 14 includes a slope 14a corresponding to the slope 13b and a slope 14b extending substantially parallel to the slope 14a. Further, the second prism 14 includes a pair of side faces 14c and 14d extending substantially parallel to the travel direction of the first laser light 35 that has been totally reflected, on the plan view shown in FIG. 1. On the sectional view of the section including the optical axis of the first laser light 35 and the optical axis of the second laser light 36, the second prism 14 has a substantially parallelogram sectional shape. A thickness direction of the second prism 14 substantially corresponds to an extension direction of the optical axis of the second laser light 36 before entering the first polarized wave combining prism 11, A thickness T of the second prism 14 may be any thickness but is preferably ⅓ of the distance P between the optical axes of the first laser device 5 and the second laser device 6, or less. On the plan view of FIG. 1, a length of the side face 13c of the first prism 13 is longer than a length of the side face 14c of the second prism 14.

The dielectric multilayer film 42 is provided on the slope 13b of the first prism 13 or the slope 14a of the second prism 14 in such a manner as to cover the slope 13b or 14a by a vacuum deposition method or the like. The first polarized wave combining prism 11 is formed, for example, by connecting one of the slope 13b or the slope 14a that has been coated with the dielectric multilayer film 42 and the other of the slope 13b and the slope 14a that has not been coated with the dielectric multilayer film 42 with transparent adhesive or by optical contact. The first wave plate 21 is connected to a side face 14c on the second laser device 6 side of the second prism 14 with transparent adhesive or by optical contact. The first wave plate 21 is a plate member and includes a pair of side faces 21a and 21b extending in parallel to the side face 14c on the plan view of FIG. 1.

In the above configuration, the first laser light 35 and the second laser light 36 travel as described below. Specifically, after traveling straight substantially parallel to the reference axis 39, the first laser light 35 emitted from the first laser device 5 changes its travel direction by substantially 90° by being reflected by the slope 13a, and travels to the third laser device 7 side in the first prism 13.

Meanwhile, the second laser light 36 emitted from the second laser device 6 travels into the first wave plate 21 after traveling straight substantially parallel to the reference axis 39, and its polarization state is changed by the first wave plate 21. Specifically, all polarization directions of light emitted from the first to fourth laser devices 5 to 8 are parallel to the drawing surface, and the light emitted from the first to fourth laser devices 5 to 8 are P-polarized. Further, the polarization directions of the light emitted from the first and fourth laser devices 5 and 8 are turned by 90° and change from the directions parallel to the drawing surface to directions perpendicular to the drawing surface in the wave plates 21 and 22, and the second and fourth laser light 36 and 35 after passing through the wave plates 21 and 22 are S-polarized.

Polarization states of the first laser light 35 and the second laser light 36 are different from each other by being changed by the first wave plate 21. In other words, the first wave plate 21 changes a state of incident polarization of the first laser light 35 that enters the polarized wave combining surface 41 and a state of incident polarization of the second laser light 36 that enters the polarized wave combining surface 41. Specifically, all, or substantially all, of the first laser light 35 that is P-polarized is transmitted through the polarized wave combining surface 41, and all, or substantially all, of the second laser light 36 that is S-polarized is totally reflected by the polarized wave combining surface 41. As a result, the first laser light 35 and the second laser light 36 are overlapped in such a manner that their optical axes substantially correspond to each other on the polarized wave combining surface 41, and travel on the same area on space after being overlapped. The overlapped laser light (hereinafter referred to as first combined laser light) 43 is totally reflected by the slope 14b in the second prism and travel substantially parallel to the reference axis 39 in such a manner that they move away from the light source substrate 2.

The second prism 14 and the dielectric multilayer film 42 constitute a second optical axis translator that translates the optical axis of the second laser light 36 emitted from the second laser device 6, and that is configured with a part of the first polarized wave combining prism 11 constituting the first optical axis translator. As for an area on the opposite side relative to the symmetry plane 40, a fourth prism 16 and a dielectric multilayer film 47 constitute a fourth optical axis translator that translates an axis of the fourth laser light 38 emitted from the fourth laser device 8, and are configured with a part of the second polarized wave combining prism 12 constituting the second optical axis translator. As described above, the first laser light 35 and the second laser light 36 are overlapped on the polarized wave combining surface 41. Therefore, the optical axis of the first laser light 35 and the optical axis of the second laser light 36 are in an overlapped state after passing through the first polarized wave combining prism 11.

As shown in FIG. 1, the condensing lens 25 is arranged on the reference axis 39 substantially plane-symmetrically relative to the symmetry plane 40. The condensing lens 25 has a convex surface 25a, and the convex surface 25a is oriented to face toward the light source substrate 2 side, An end portion of an optical incident side of the optical fiber 30 is arranged on the reference axis 39. Second combined laser light 48 is generated with the same mechanism as the first combined laser light 43, in an area on a side opposite to the side where the first combined laser light is generated, substantially plane-symmetrically with the first combined laser lights 43 relative to the symmetry plane 40. After being condensed on the reference axis 39 by the condensing lens 25, the first combined laser light 43 and the second combined laser light 48 enter the optical fiber 30 from an incident side opening 31 of the optical fiber 30 and are combined with the optical fiber 30. As for each of the laser devices 5 to 8 that emit lights to enter the incident side opening 31 of the optical fiber 30, a light output of each of the laser devices 5 to 8 may be any light output but is preferably between 1 W (watt) and 100 W, inclusive.

The laser light that has entered the optical fiber 30 reaches a predetermined position with a low loss due to the optical fiber 30, though it is not described in detail. The laser light emitted from an emission side end portion of the optical fiber 30 directly enters a luminous body or enters the luminous body via an optical part such as a mirror. The luminous body plays a role of wavelength-converting the laser light. The luminous body is formed, for example, by phosphor-containing resin obtained by dispersing phosphor particles in silicone resin. In the case where the laser light is emitted blue light, like the present example, the luminous body emits a white light if the phosphor particles are configured with YAG-based yellow phosphors. This white light is used as an illumination light.

To return to the description of the whole configuration of the light source device 1, an optical axis movement distance ΔX1 of the first laser light 35 by the first optical axis translator is larger than an optical axis movement distance X2 of the second laser light 36 by the second optical axis translator as shown in FIG. 1. The optical axis movement distance ΔX1 of the first laser light 35 is larger than the distance P between the optical axes of the first laser device 5 and the second laser device 6, and the optical axis movement distance ΔX2 of the second laser light 36 is smaller than the distance P between the optical axes. As for the optical axis movement distances ΔX1 and ΔX2 of the first and second laser lights 35 and 36 by the optical axis translating portion 10 and the distance P between the optical axes of the first laser device 5 and the second laser device 6, a relationship of ΔX1≈P+ΔX2 is preferably satisfied.

As described above, the light source device 1 is provided with the plurality of laser devices 5 to 8 including the first laser device 5 and the second laser device 6. The plurality of laser light emitted from the plurality of laser devices 5 to 8 includes the laser light 35 to 38 that passes through the optical axis translating portion 10 where the optical axes translate. The plurality of laser devices 5 to 8 include the first laser device 5 and the third laser device 7, the distance between which is the longest. An area on a side opposite to a side where the plurality of laser devices 5 to 8 exist, with the optical axis translating portion 10 as a border, is assumed to be an outer side area R2, and an area on the side where the plurality of laser devices 5 to 8 exist, with the optical axis translating portion 10 as the border, is assumed to be an inner side area R1. Here, a distance W2 between the optical axis of the first laser light 35 and the optical axis of the third laser light 37 in the outer side area R2 is smaller than a distance W1 between the optical axis of the first laser light 35 and the optical axis of the third laser light 37 in the inner side area R1, and, especially, the distance W2 is preferably ⅓ of the distance W1, or less. In the present example, the first laser device 5 constitutes a laser device on a first end side, and the third laser device 7 constitutes a laser device on a second end side. The first laser light 35 constitutes a laser light on the first end side, and the third laser light 37 constitutes a laser light on the second end side.

As described above, the light source device 1 for an illumination apparatus is provided with the first laser device 5 that emits the first laser light 35 and the second laser device 6 that emits the second laser light 36 having an optical axis extending substantially parallel to the optical axis of the first laser light 35. The light source device 1 is provided with the first optical axis translator that translates the optical axis of the first laser light 35 emitted from the first laser device 5 and the second optical axis translator that translates the optical axis of the second laser light 36 emitted from the second laser device 6. A distance between the optical axis of the first laser light 35 before entering the first optical axis translator and the optical axis of the second laser light 36 before entering the second optical axis translator is longer than a distance between the optical axis of the first laser light 35 after passing through the first optical axis translator and the optical axis of the second laser light 36 after passing through the second optical axis translator.

According to the above configuration, it is possible to change the distance between the first and second laser light 35 and 36 before and after the optical axis translating portion 10 by the first and second optical axis translators. Therefore, it is possible to increase the distance P between the optical axes of the first and second laser devices 5 and 6 enough to sufficiently perform heat dissipation of the first and second laser devices 5 and 6 in the inner side area R1.

Furthermore, in contrast with the inner side area R_1, the distance between the first and second laser light 35 and 36 can be reduced in the outer side area R2. Therefore, since a laser light width (an optical axis width) can be reduced, laser light can be condensed onto the incident side opening 31 with a small spot diameter. As a result, an inexpensive optical fiber with a small diameter can be used as the optical fiber 30 arranged in the outer side area R2.

The optical axis movement distance ΔX1 of the first laser light 35 by the first optical axis translator may be larger than the optical axis movement distance ΔX2 of the second laser light 36 by the second optical axis translator.

According to the above configuration, it is possible to arrange the optical fiber 30 in an area on a side opposite to an area on a side where the first laser light 35 before reaching the optical axis translating portion 10 exists, relative to the second laser light 36 before reaching the optical axis translating portion 10. It is possible to cause the first and second laser light 35 and 36 after passing through the optical axis translating portion 10 to enter the incident side opening 31 of the optical fiber 30.

The optical axis movement distance ΔX1 of the first laser light 35 may be larger than the distance P between the optical axes of the first laser device 5 and the second laser device 6, and the optical axis movement distance ΔX2 of the second laser light 36 may be smaller than the distance P between the optical axes.

According to the above configuration, a difference between the optical axis movement distance ΔX1 of the first laser light 35 and the optical axis movement distance ΔX2 of the second laser light 36 is increased. Therefore, the distance P between the optical axes of the first laser device 5 and the second laser device 6 can be increased, and heat dissipation of the first and second laser devices 5 and 6 can be efficiently performed.

A section obtained by cutting along a plane including the optical axis of the first laser light 35 emitted from the first laser device 5 and the optical axis of the second laser light 36 emitted from the second laser device 6 will be considered. Here, the first optical axis translator may include the first prism 13, the sectional shape of which on the section is substantially a parallelogram, and the thickness direction of which substantially corresponds to the extension direction of the optical axis of the first laser light 35 before entering the first optical axis translator. The second optical axis translator may include the second prism 14, the sectional shape of which on the section is substantially a parallelogram, and the thickness direction of which substantially corresponds to the extension direction of the optical axis of the second laser light 36 before entering the second optical axis translator.

According to the above configuration, the first and second optical axis translators can be configured with prisms and can be realized with a simple configuration.

The second optical axis translator may be configured with a part of the first optical axis translator.

According to the above configuration, it becomes possible for the second laser fight 36 to travel in the first optical axis translator. Therefore, it is possible to reduce the distance between the optical axes of the first and second laser light 35 and 36 after passing through the optical axis translating portion 10. Therefore, it is possible to further reduce the spot diameters of laser light caused to enter the optical fiber 30 and further increase efficiency of combination to a fiber with a small diameter.

The first laser light 35 after passing through the first optical axis translator and the second laser light 36 after passing through the second optical axis translator may be overlapped in such a manner that the optical axis of the first laser light 35 and the optical axis of the second laser light 36 substantially correspond to each other. The second optical axis translator may include the polarized wave combining surface 41. The first laser light 35 may be transmitted through the polarized wave combining surface 41, while the second laser light 36 may be reflected by the polarized wave combining surface 41.

According to the above configuration, the first laser light 35 and the second laser light 36 are overlapped with each other. Therefore, it is possible to further reduce the spot diameters of laser light caused to enter the optical fiber 30 and further increase the efficiency of combination to a fiber with a small diameter.

The light source device 1 may be provided with the third laser device 7 that emits the third laser light 37 and the fourth laser device 8 that emits the fourth laser light 38 having an optical axis extending substantially parallel to the optical axis of the third laser light 37. The light source device 1 may be provided with the third optical axis translator that translates the optical axis of the third laser light 37 emitted from the third laser device 7 and the fourth optical axis translator that translates the optical axis of the fourth laser light 38 emitted from the fourth laser device 8. A sectional view of a section including the optical axis of the first laser light 35 before entering the first optical axis translator and the optical axis of the second laser light 36 before entering the second optical axis translator will be considered. Here, there may be a reference axis 39 relative to which the first laser device 5 and the third laser device 7, the second laser device 6 and the fourth laser device 8, the first optical axis translator and the third optical axis translator, and the second optical axis translator and the fourth optical axis translator, are substantially line-symmetric.

According to the above configuration, it is possible to line-symmetrically generate two sets of the first and second combined laser light 43 and 48, with the reference axis 39 as a border, and it is possible to double the strength of laser light that enters the same optical fiber 30. Therefore, it is possible to generate an illumination light having excellent brightness.

The thickness T of the second prism 14 may be ⅓ of the distance P between the optical axes of the first laser device 5 and the second laser device 6, or less.

The thinner the thickness of a prism is, the more accurately travel direction control of a laser light traveling in a direction orthogonal to a thickness direction of the prism can be performed. Therefore, it is easy to increase an optical axis translating distance. According to the above configuration, the thickness T of the second prism 14 is ⅓ of the distance P between the optical axes, or less. Therefore, it is possible to increase the optical axis movement distance ΔX2 of the second laser light 36.

The distance W2 between the optical axis of the first laser light 35 and the optical axis of the third laser light 37 in the outer side area R2 may be ⅓ of the distance W1 between the optical axis of the first laser light 35 and the optical axis of the third laser light 37 in the inner side area R1, or less.

According to the above configuration, the laser light width (the optical axis width) can be effectively reduced.

The light source device 1 may be provided with the optical fiber 30 having the incident side opening 31 which the first laser light 35 and the second laser light 36 enter in a state of being overlapped. A total of light outputs of all the first to fourth laser devices 5 to 8 that emit light to enter the incident side opening 31 may be between 1 W (watt) and 100 W, inclusive.

According to the above configuration, it is easy to generate an illumination light suitable for illumination using laser light having travel directions that are controlled by the optical fiber 30.

The present disclosure is not limited to the above embodiment and its modifications, but various improvements and changes are possible within matters described in the claims of the present application and within a range equal to the matters.

For example, in the above embodiment, the first and third laser devices 5 and 7, the second and fourth laser devices 6 and 8, and the first and second polarized wave combining prisms 11 and 12 are line-symmetrically arranged relative to the symmetry plane 40. However, as show in FIG. 2, that is, a plan view of a light source device 101 for an illumination apparatus of a modification corresponding to FIG. 1, a plane (a symmetry plane) making the light source device 101 substantially plane-symmetric may not exist. In comparison with the light source device 1 shown in FIG. 1, the condensing lens 25 may be omitted, and the light source device 101 may be provided with only components arranged on an area on one side with the symmetry plane 40 as a border, that is, only the first laser device 5, the second laser device 6, the first polarized wave combining prism 11 and the first wave plate 21. The first combined laser light 43 may directly enter an opening on an incident side of an optical fiber (not shown) without passing through a condensing lens.

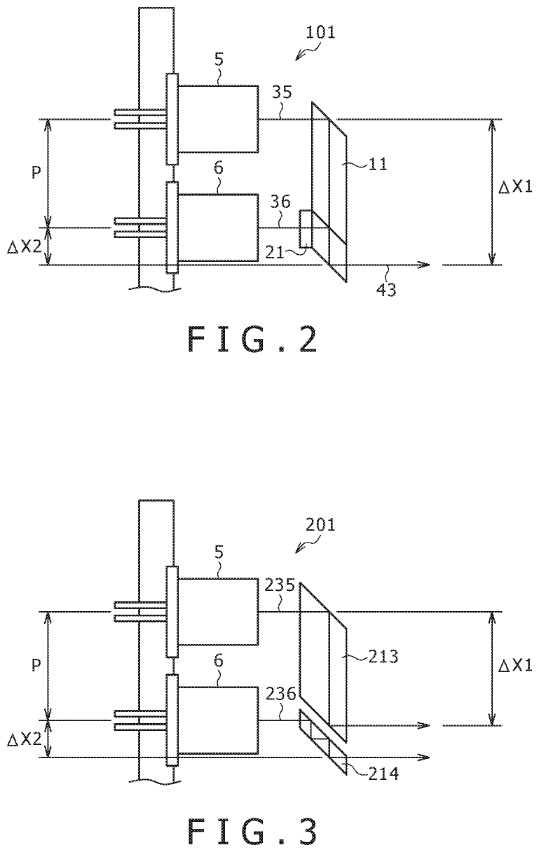

Description has been given for the case where the second optical axis translator is configured with the second prism 14 and the dielectric multilayer film 42, and the second prism 14 and the dielectric multilayer film 42 are configured with a part of the one first polarized wave combining prism 11 constituting the first optical axis translator. However, the second optical axis translator may be arranged away from the first optical axis translator. Specifically, as shown in FIG. 3, that is, a plan view of a light source device 201 of a further modification corresponding to FIG. 1, the first optical axis translator may be configured with a first prism 213, and the second optical axis translator may be configured with a second prism 214 arranged away from the first prism 213. On a sectional view of a section including an optical axis of a first laser light 235 and an optical axis of a second laser light 236, the first prism 213 may have a substantially parallelogram sectional shape. A thickness direction of the first prism 213 may substantially correspond to an extension direction of the optical axis of the first laser light 235 before entering the first prism 213. On the sectional view, the second prism 214 may have a substantially parallelogram sectional shape. A thickness direction of the second prism 214 may substantially correspond to an extension direction of the optical axis of the second laser light 236 before entering the second prism 214.

Description has been given for the case where each of the laser lights 35 to 38 emitted from all the laser devices 5 to 8 translates in such a manner that the optical axis translates, by an optical axis translator. However, a plurality of laser devices that a light source device is provided with may include such a laser device that its emitted laser light travels straight and directly enters an optical fiber without passing through an optical axis translator. For example, two sets of a plurality of laser devices may be plane-symmetrically arranged with a reference axis as a border, and one laser device on the reference axis and an incident side opening of an optical fiber may be arranged on the reference axis. Each of laser light emitted from the two sets of the plurality of laser devices may be caused to enter the incident side opening by an optical axis translator and a condensing lens, and a laser light emitted from the laser device on the reference axis may be caused to enter the incident side opening after being caused to pass through a center of the condensing lens. Thus, the light source device may be provided with an optical fiber having an incident side opening which both of a first laser light and a second laser light enter, or the first laser light and the second laser light enter in a state of being overlapped. The light source device may be further provided with a laser device on a reference axis as a third laser device such that its emitted laser light directly enters the incident side opening without translation of an optical axis.

Description has been given for the case where the optical axis movement distance ΔX1 of the first laser light 35 by the first optical axis translator is larger than the optical axis movement distance ΔX2 of the second laser light 36 by the second optical axis translator. However, an optical axis movement distance ΔX1 of a first laser light by the first optical axis translator may be the same as an optical axis movement distance ΔX2 of a second laser light by the second optical axis translator. Specifically, the first laser device and the second laser device may be plane-symmetrically arranged relative to a plane including a reference axis. Then, the first laser light and the second laser light may be caused to enter an incident side opening of an optical fiber located on the reference axis after causing the first laser light and the second laser light to translate to the reference axis by the first and second optical axis translators.

Description has been given for the case where the optical axis translating portion 10 includes the prisms 13 to 16. However, an optical axis translating portion may not include prisms but may include mirrors instead of prisms.

For example, in the case of the modification shown in FIG. 3, by reflecting a first laser light twice using two mirrors, namely first and second mirrors instead of the first prism 213, the first laser light may be caused to travel on the same route as the first laser light 235. Further, by reflecting a second laser light twice or more using two mirrors, namely third and fourth mirrors instead of the second prism 214, the second laser light may be caused to travel on the same route as the second laser light 236. In this case, it goes without saying that the first optical axis translator includes the first and second mirrors, and the second optical axis translator includes the third and fourth mirrors.

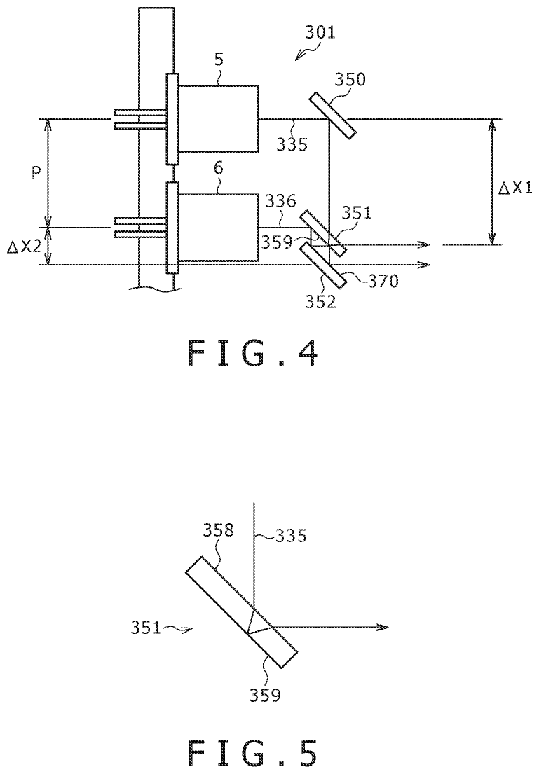

In such a case, the second mirror may also serve as the third mirror. Specifically, as shown in FIG. 4, that is, a plan view of a light source device 301 for an illumination apparatus of another modification corresponding to FIG. 1, a first laser light 335 emitted from the first laser device 5 may be reflected by a first mirror 350 and a face 359 of a second mirror 351 on a side opposite to the first mirror 350 side. Further, a second laser light 336 emitted from the second laser device 6 may be reflected by the face 359 of the second mirror 351 and a face 370 of a fourth mirror 352 on the first mirror 350 side. In this case, it is preferable to apply antireflection coating to a face 358 of the second mirror 351 on the first mirror 350 side, with reference to FIG. 5, that is, a schematic diagram illustrating a structure of the second mirror 351. Further, it is preferable to apply antireflection coating to the face 359 of the second mirror 351 on the side opposite to the first mirror 350 side.

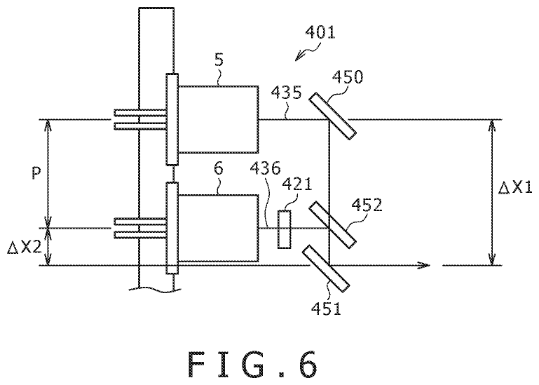

In the case of the modification shown in FIG. 2, a first mirror, a second mirror and a third polarized wave combining mirror may be adopted instead of the first polarized wave combining prism 11. Specifically, with reference to FIG. 6, that is, a plan view of a light source device 401 for an illumination apparatus of another modification corresponding to FIG. 1, a P-polarized first laser light 435 may be reflected twice by a first mirror 450 and a second mirror 451, and the P-polarized first laser light 435 may be transmitted through a third polarized wave combining mirror 452. A P-polarized second laser light 436 may be emitted from the second laser device 6. Then, the second laser light 436 from the second laser device 6 may be transmitted through a wave plate 421 configured with a λ/2 wave plate or the like. Further, the second laser light 436 which has been S-polarized by passing through the wave plate 421 may be reflected twice by the third polarized wave combining mirror 452 and the second mirror 451. Then, the first laser light 435 and the second laser light 436 may be overlapped on a polarized wave combining surface 441 of the third polarized wave combining mirror 452.

Description has been given for the case where overlapping of the first laser light 35 and the second laser light 36 is performed by causing the polarization state of the second laser light 36 to fluctuate using the first wave plate 21. However, a light source device may not have a wave plate, and a first laser light and a second laser light may be overlapped by changing wavelengths of the first laser light and the second laser light. In this case, for example, the wavelengths of the first laser light and the second laser light may be changed by implementing first and second laser devices, that emit laser light with different wavelengths, on a substrate. This configuration can be easily realized, for example, by omitting the first wave plate 21 and causing a wavelength of the first laser light 35 emitted by the first laser device 5 to be different from a wavelength of the second laser light 36 emitted by the second laser device 6 in the configuration shown in FIG. 2, Though description has been given for the case where a light source device is provided with two or four laser devices, a light source device may be three, five or more laser devices.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A light source device for an illumination apparatus, the light source device comprising:
a first laser device that emits a first laser light;
a second laser device that emits a second laser light, the second laser light having an optical axis extending substantially parallel to an optical axis of the first laser light;
a first optical axis translator that translates the optical axis of the first laser light emitted from the first laser device; and
a second optical axis translator that translates the optical axis of the second laser light emitted from the second laser device; wherein
a distance between the optical axis of the first laser light before translation by the first optical axis translator and the optical axis of the second laser light before translation by the second optical axis translator is greater than a distance between the optical axis of the first laser light after translation by the first optical axis translator and the optical axis of the second laser light after translation by the second optical axis translator.

2. The light source device according to claim 1, wherein an optical axis movement distance of the first laser light by the first optical axis translator is greater than an optical axis movement distance of the second laser light by the second optical axis translator.

3. The light source device according to claim 2, wherein the optical axis movement distance of the first laser light is greater than a distance between optical axes of the first laser device and the second laser device, and the optical axis movement distance of the second laser light is less than the distance between the optical axes.

4. The light source device according to claim 1, wherein
the first optical axis translator includes a first prism, a sectional shape of the first prism, along a plane including the optical axis of the first laser light before translation by the first optical axis translator and the optical axis of the second laser light before translation by the second optical axis translator, substantially being a parallelogram, and a thickness direction of the first prism substantially corresponding to an extension direction of the optical axis of the first laser light before translation by the first optical axis translator, and
the second optical axis translator includes a second prism, a sectional shape of the second prism, along the plane, substantially being a parallelogram, and a thickness direction of the second prism substantially corresponding to an extension direction of the optical axis of the second laser light before translation by the second optical axis translator.

5. The light source device according to claim 4, wherein the second optical axis translator includes a part of the first optical axis translator.

6. The light source device according to claim 5, wherein
the first laser light after translation by the first optical axis translator overlaps and substantially corresponds with the second laser light after translation by the second optical axis translator,
the second optical axis translator includes a polarized wave combining surface,
the first laser light is transmitted through the polarized wave combining surface, and
the second laser light is reflected by the polarized wave combining surface.

7. The light source device according to claim 1, further comprising:
a third laser device that emits a third laser light;
a fourth laser device that emits a fourth laser light, the fourth laser light having an optical axis extending substantially parallel to an optical axis of the third laser light;
a third optical axis translator that translates the optical axis of the third laser light emitted from the third laser device; and
a fourth optical axis translator that translates the optical axis of the fourth laser light emitted from the fourth laser device; wherein
each pair of the first laser device and the third laser device, the second laser device and the fourth laser device, the first optical axis translator and the third optical axis translator, and the second optical axis translator and the fourth optical axis translator are substantially line-symmetric relative to a reference axis, the reference axis being on a sectional view of a section including the optical axis of the first laser light before translation by the first optical axis translator and the optical axis of the second laser light before translation by the second optical axis translator.

8. The light source device according to claim 4, wherein a thickness of the second prism is at most ⅓ of the distance between the optical axes of the first laser device and the second laser device.

9. The light source device according to claim 1, further comprising:
a plurality of laser devices including the first laser device and the second laser device, wherein
a plurality of laser lights beams emitted from the plurality of laser devices includes one or more laser light beams passing through an optical axis translator that translates optical axes, and
for a laser device on a first end side and a laser device on a second end side that are farthest apart among the plurality of laser devices, when the laser device on the first end side emits laser light on the first end side and the laser device on the second end side emits laser light on the second end side, a distance between an optical axis of the laser light on the first end side and an optical axis of the laser light on the second end side in an outer side area on a side opposite to a side where the plurality of laser devices is disposed with regard to the optical axis translator as a border, is at most ⅓ of a distance between the optical axis of the laser light on the first end side and the optical axis of the laser light on the second end side in an inner side area on the side where the plurality of laser devices is disposed with regard to the optical axis translator as the border.

10. The light source device according to claim 1, further comprising:
an optical fiber including an incident side opening, into which both of the first laser light and the second laser light enter, or into which the first laser light and the second laser light enter in a state of being overlapped; and
a third laser device that emits a laser light directly into the incident side opening without translation of an optical axis of the laser light emitted by the third laser device.

11. The light source device according to claim 1, further comprising:
an optical fiber including an incident side opening, into which both of the first laser light and the second laser light enter, or into which the first laser light and the second laser light enter in a state of being overlapped, wherein
a total of light outputs of all laser devices emitting light into the incident side opening is between 1 W and 100 W, inclusive.

12. The light source device according to claim 1, wherein
the first optical axis translator includes a first mirror and a second mirror, and
the second optical axis translator includes a third mirror and a fourth mirror.

13. The light source device according to claim 6, further comprising:
a wave plate by which a state of incident polarization of the first laser light entering the polarized wave combining surface changes a state of incident polarization of the second laser light entering the polarized wave combining surface.

14. The light source device according to claim 6, wherein a wavelength of the first laser light emitted by the first laser device is different from a wavelength of the second laser light emitted by the second laser device.
